(19) United States
(12) Patent Application Publication
(10) Pub. No.: US 2021/0387886 A1
(43) Pub. Date: Dec. 16, 2021

(54) STERILIZATION METHOD FOR WATER SYSTEM, METHOD OF REMOVING NITROSAMINE COMPOUND FROM WATER SYSTEM AND DRINKING WATER PRODUCTION METHOD

(71) Applicant: ORGANO CORPORATION, Tokyo (JP)

(72) Inventors: Hiro YOSHIKAWA, Tokyo (JP); Yudai SUZUKI, Tokyo (JP); Masahiro EGUCHI, Tokyo (JP)

(73) Assignee: ORGANO CORPORATION, Tokyo (JP)

(21) Appl. No.: 17/417,485

(22) PCT Filed: Jul. 12, 2019
(86) PCT No.: PCT/JP2019/027763

§ 371 Date: Jun. 23, 2021

(30) Foreign Application Priority Data
Dec. 27, 2018 (JP) 2018-245052
May 13, 2019 (JP) 2019-090822

(51) Int. Cl. C02F 9/00

(52) U.S. Cl. CPC C02F 9/00; C02F 2101/38

(57) ABSTRACT

Provided is a sterilization method for a water system, the sterilization method being capable of suppressing the production amount of a nitrosamine compound while exhibiting a sufficient sterilization effect in precursor-containing water that contains a nitrosamine compound precursor. In the sterilization method for a water system, a stabilizing composition containing a bromine-based oxidizing agent or a chlorine-based oxidizing agent and a sulfamic acid compound is added to the precursor-containing water that contains the nitrosamine compound precursor.

### TECHNICAL FIELD

The present invention relates to a sterilization method for a water system, a method of removing a nitrosamine compound from a water system, and a production method for drinking water.

### BACKGROUND

The World Health Organization (WHO) has prescribed a drinking water quality guideline value of 100 ng/L for the nitrosamine compound N-nitrosodimethylamine (NDMA), and some countries have set this value to 10 ng/L. It has been reported that this NDMA is produced from an NDMA precursor and chloramine which is used for water sterilization (see Patent Document 1, non-Patent Document 1). Examples of nitrosamine compound precursors such as NDMA precursors that have been reported include amines such as dimethylamine and trimethylamine (see non-Patent Document 2).

Examples of water containing an NDMA precursor include secondary treated sewage. Chloramine is sometimes used for sterilization or the like of water containing an NDMA precursor such as secondary treated sewage, but if chloramine is used, then NDMA is sometimes produced as a by-product. Further, wastewater such as this type of secondary treated sewage may sometimes also contain ammonia within the water, and in such cases, if the typical sterilizing agent hypochlorous acid is used for sterilization or the like of the water, then reaction of the ammonia and hypochlorous acid in the water can form chloramine, and reaction of this chloramine with an NDMA precursor may also sometimes produce NDMA.

In these types of cases, the NDMA must be removed by a reverse osmosis membrane (RO membrane) or an advanced oxidation process using ultraviolet (UV) light or the like at a stage subsequent to the sterilization treatment.

Accordingly, a sterilization method for a water system capable of suppressing the amount of nitrosamine compounds produced while exhibiting a satisfactory sterilization effect in water containing a nitrosamine compound precursor would be desirable.

### CITATION LIST

### Patent Literature

Patent Document 1: JP 4984292 B

### Non-Patent Literature

Non-Patent Document 1: Huy et al., Water Research, 45 (2011), pp. 3369 to 3377
Non-Patent Document 2: Selbes et al., Water Research, 140 (2018), pp. 100 to 109
Non-Patent Document 3: Kodamatani et al., Journal of Chromatography A, 1553 (2018), pp. 51 to 56

### SUMMARY

### Technical Problem

An object of the present invention is to provide a sterilization method for a water system capable of suppressing the amount of nitrosamine compounds produced while exhibiting a satisfactory sterilization effect in a precursor-containing water that contains a nitrosamine compound precursor.

Further, another object of the present invention is to provide a method of removing a nitrosamine compound from a water system which is capable of removing a produced nitrosamine compound from a precursor-containing water that contains a nitrosamine compound precursor.

Furthermore, another object of the present invention is to provide a drinking water production method capable of producing drinking water having a low nitrosamine compound content from a precursor-containing water that contains a nitrosamine compound precursor.

### Solution to Problem

The present invention provides a sterilization method for a water system in which a stabilized composition containing a bromine-based oxidizing agent or a chlorine-based oxidizing agent and a sulfamic acid compound is added to a precursor-containing water that contains a nitrosamine compound precursor.

In the above sterilization method for a water system, the nitrosamine compound precursor preferably includes at least one compound from among dimethylamine, trimethylamine, N,N-dimethylisopropylamine, N,N-dimethylbenzylamine, ranitidine, tetramethylthiuram disulfide, dimethyldithiocarbamate, polydiallyldimethylammonium chloride, and polymers containing an amino group.

In the above sterilization method for a water system, the concentration of the nitrosamine compound precursor in the precursor-containing water, expressed as a nitrosamine compound production potential, is preferably at least 100 ng/L.

In the above sterilization method for a water system, it is preferable that the nitrosamine compound precursor includes at least one of dimethylamine, trimethylamine and N,N-dimethylbenzylamine, and that the concentration of the nitrosamine compound precursor in the precursor-containing water is at least 100 μg/L.

In the above sterilization method for a water system, the bromine-based oxidizing agent is preferably bromine, bromine chloride, or a reaction product of a bromine compound and a chlorine-based oxidizing agent.

In the above sterilization method for a water system, the chlorine-based oxidizing agent is preferably hypochlorous acid or a salt thereof.

In the above sterilization method for a water system, the stabilized composition is preferably added so that the effective halogen concentration (effective chlorine equivalent concentration) in the precursor-containing water is not more than 3 mgCl/L.

In the above sterilization method for a water system, the time for which the precursor-containing water and the stabilized composition are in continuous contact is preferably not longer than 5 hours.

In the above sterilization method for a water system, following addition of the stabilized composition to the precursor-containing water, at least one treatment among a separation membrane treatment and an oxidative degradation treatment is preferably conducted.

In the above sterilization method for a water system, the separation membrane used in the separation membrane treatment is preferably a reverse osmosis membrane.

The present invention also provides a method of removing a nitrosamine compound from a water system in which a stabilized composition containing a bromine-based oxidizing agent or a chlorine-based oxidizing agent and a sulfamic acid compound is added to a precursor-containing water that contains a nitrosamine compound precursor, and a reverse osmosis membrane treatment and an oxidative degradation treatment are subsequently conducted in that order.

The present invention also provides a drinking water production method in which a stabilized composition containing a bromine-based oxidizing agent or a chlorine-based oxidizing agent and a sulfamic acid compound is added to a precursor-containing water that contains a nitrosamine compound precursor, and a reverse osmosis membrane treatment is subsequently conducted to produce the drinking water.

In the above drinking water production method, the precursor-containing water is preferably a secondary treated sewage.

### Advantageous Effects of Invention

The present invention is able to provide a sterilization method for a water system capable of suppressing the amount of nitrosamine compounds produced while exhibiting a satisfactory sterilization effect in a precursor-containing water that contains a nitrosamine compound precursor.

Further, the present invention also provides a method of removing a nitrosamine compound from a water system which is capable of removing a produced nitrosamine compound from a precursor-containing water that contains a nitrosamine compound precursor.

Furthermore, the present invention also provides a drinking water production method capable of producing drinking water having a low nitrosamine compound content from a precursor-containing water that contains a nitrosamine compound precursor.

### BRIEF DESCRIPTION OF DRAWINGS

FIG. 1 is a schematic structural diagram illustrating one example of a water treatment device using the sterilization method according to an embodiment of the present invention.

FIG. 2 is a graph illustrating the effects of antibacterial agent concentration and reaction time on the NDMA production amount in Example 1-5.

FIG. 3 is a graph illustrating the effects of antibacterial agent concentration and reaction time on the NDMA production amount in Example 1-6.

FIG. 4 is a graph illustrating the change in water passage differential pressure when a test water containing a composition 1 is passed through an RO membrane.

### DESCRIPTION OF EMBODIMENTS

Embodiments of the present invention are described below. These embodiments are merely examples of implementing the present invention, and the present invention is not limited to these embodiments.

A sterilization method for a water system according to an embodiment of the present invention is a method in which a stabilized composition containing a bromine-based oxidizing agent or a chlorine-based oxidizing agent and a sulfamic acid compound is added to a nitrosamine compound precursor-containing water (hereafter sometimes referred to as simply “the precursor-containing water”) that contains a nitrosamine compound precursor.

The “stabilized composition containing a bromine-based oxidizing agent and a sulfamic acid compound” may be a stabilized hypobromous acid composition containing a mixture of a “bromine-based oxidizing agent” and a “sulfamic acid compound”, or may be a stabilized hypobromous acid composition containing a “reaction product of a bromine-based oxidizing agent and a sulfamic acid compound”. The “stabilized composition containing a chlorine-based oxidizing agent and a sulfamic acid compound” may be a stabilized hypochlorous acid composition containing a mixture of a “chlorine-based oxidizing agent” and a “sulfamic acid compound”, or may be a stabilized hypochlorous acid composition containing a “reaction product of a chlorine-based oxidizing agent and a sulfamic acid compound”.

In other words, in the sterilization method according to an embodiment of the present invention, a mixture of a “bromine-based oxidizing agent” and a “sulfamic acid compound”, or a mixture of a “chlorine-based oxidizing agent” and a “sulfamic acid compound” is added to the precursor-containing water. It is thought that this results in the production of a stabilized hypobromous acid composition or a stabilized hypochlorous acid composition within the precursor-containing water.

Further, in the sterilization method according to an embodiment of the present invention, a stabilized hypobromous acid composition that is a “reaction product of a bromine-based oxidizing agent and a sulfamic acid compound” or a stabilized hypochlorous acid composition that is a “reaction product of a chlorine-based oxidizing agent and a sulfamic acid compound” is added to the precursor-containing water.

More specifically, in the sterilization method according to an embodiment of the present invention, a mixture of a “sulfamic acid compound” and “bromine”, “bromine chloride”, “hypobromous acid” or a “reaction product of sodium bromide and hypochlorous acid” is added to the precursor-containing water. Alternatively, a mixture of “hypochlorous acid” and a “sulfamic acid compound” is added to the precursor-containing water.

Furthermore, in the sterilization method according to an embodiment of the present invention, a stabilized hypobromous acid composition that is a “reaction product of bromine and a sulfamic acid compound”, a “reaction product of bromine chloride and a sulfamic acid compound”, a “reaction product of hypobromous acid and a sulfamic acid compound”, or a “reaction product of a sulfamic acid compound with the reaction product of sodium bromide and hypochlorous acid” is added to the precursor-containing water. Alternatively, a stabilized hypochlorous acid composition that is a “reaction product of hypochlorous acid and a sulfamic acid compound” is added to the precursor-containing water.

In the sterilization method according to an embodiment of the present invention, the stabilized hypobromous acid composition or stabilized hypochlorous acid composition has a sterilizing effect that is at least as favorable as chlorine-based oxidizing agents such as chloramine and exhibits a biofouling suppression effect, and yet is less likely to react with nitrosamine compound precursors than chloramine, and therefore even when used as an antibacterial agent for a nitrosamine compound precursor-containing water, the amount of nitrosamine compounds produced can be suppressed. Accordingly, the stabilized hypobromous acid composition or stabilized hypochlorous acid composition used in the sterilization method according to an embodiment of the present invention is ideal as an antibacterial agent for nitrosamine compound precursor-containing water.

Among the various possible sterilization methods according to embodiments of the present invention, a “stabilized composition containing a bromine-based oxidizing agent and a sulfamic acid compound” provides a superior sterilizing effect to a “stabilized composition containing a chlorine-based oxidizing agent and a sulfamic acid compound”, and is consequently preferred.

Among the various possible sterilization methods according to embodiments of the present invention, in those cases where the “bromine-based oxidizing agent” is bromine, because there is no chlorine-based oxidizing agent present, if a separation membrane treatment is conducted at a subsequent stage to the sterilization treatment, then the degradative effect on the separation membrane is extremely small.

In a sterilization method using a reverse osmosis membrane according to an embodiment of the present invention, the “bromine-based oxidizing agent” or “chlorine-based oxidizing agent” and the “sulfamic acid compound” may, for example, be injected into the precursor-containing water using a chemical feed pump or the like. The “bromine-based oxidizing agent” or “chlorine-based oxidizing agent” and the “sulfamic acid compound” may be added separately to the precursor-containing water, or the neat liquids may be mixed together and then added to the precursor-containing water.

Alternatively, a “reaction product of a bromine-based oxidizing agent and a sulfamic acid compound” or a “reaction product of a chlorine-based oxidizing agent and a sulfamic acid compound” may, for example, be injected into the precursor-containing water using a chemical feed pump or the like.

The stabilized hypobromous acid composition or stabilized hypochlorous acid composition may be added continuously or intermittently to the water system, but in terms of economic viability and the like, is preferably added intermittently.

Examples of the nitrosamine compound precursor that functions as a precursor to a nitrosamine compound include secondary amine compounds such as dimethylamine (DMA), tertiary amine compounds such as trimethylamine (TMA), N,N-dimethylisopropylamine (DMiPA), N,N-dimethylbenzylamine (DMBzA), ranitidine (RNTD), tetramethylthiuram disulfide and dimethyldithiocarbamate, quaternary amine compounds such as polydiallyldimethylammonium chloride, and other amine compounds such as polymers containing an amino group.

Examples of the nitrosamine compound include N-nitrosodimethylamine (NDMA), N-nitrosodiethylamine (NDEA), N-nitrosomorpholine (NMOR), N-nitrosomethylethylamine (NMEA), and N-nitrosopyrrolidine (NPYR).

There are no conventionally prescribed methods for evaluating the production potential of a nitrosamine compound precursor to produce a nitrosamine compound, but in this description, the nitrosamine compound production potential is defined as “the concentration of nitrosamine compound produced when monochloramine is added to a target water in an amount sufficient to generate an initial total chlorine concentration of 10 mgCl/L, and the resulting mixture is then left to stand at pH 6.0 and a temperature of 25° C. for a reaction time of 120 hours”.

The concentration of the nitrosamine compound precursor in the precursor-containing water has a nitrosamine compound production potential that is preferably at least 100 ng/L, and more preferably within a range from 1,000 ng/L to 100,000 ng/L. If the concentration of the nitrosamine compound precursor in the precursor-containing water, expressed as the nitrosamine compound production potential, is less than 100 ng/L, then the difference in the suppression effect on NDMA production compared with conventionally used antibacterial agents such as chloramine may become unnoticeable.

The concentration of the nitrosamine compound precursor in the precursor-containing water, for example, in the case of dimethylamine (DMA), trimethylamine (TMA) or N,N-dimethylbenzylamine (DMBzA), is preferably at least 10 μg/L, more preferably at least 100 μg/L, and even more preferably within a range from 100 μg/L to 100,000 μg/L. If the concentration of the nitrosamine compound precursor in the precursor-containing water is less than 10 μg/L, then the difference in the suppression effect on NDMA production compared with conventionally used antibacterial agents such as chloramine may become unnoticeable.

The stabilized composition is preferably added so that the effective halogen concentration (effective chlorine equivalent concentration) in the precursor-containing water is not more than 3 mgCl/L, and more preferably 1 mgCl/L or less. If the effective halogen concentration (effective chlorine equivalent concentration) exceeds 3 mgCl/L, then the metal members such as the lines in the equipment may sometimes corrode.

The time for which the precursor-containing water and the stabilized composition are in continuous contact is preferably not more than 5 hours, and more preferably 3 hours or less. If the time for which the precursor-containing water and the stabilized composition are in continuous contact exceeds 5 hours, then there is a possibility of a slight increase in the amount of NDMA produced.

In the sterilization method according to an embodiment of the present invention, the ratio of the equivalent weight of the “sulfamic acid compound” relative to the equivalent weight of the “bromine-based oxidizing agent” or the “chlorine-based oxidizing agent” is preferably 1 or greater, and is more preferably within a range from at least 1 to not more than 2. If the ratio of the equivalent weight of the “sulfamic acid compound” relative to the equivalent weight of the “bromine-based oxidizing agent” or the “chlorine-based oxidizing agent” is less than 1, then there is a possibility of a destabilization of the active ingredient, and if a separation membrane treatment is conducted following the sterilization treatment, there is a possibility that degradation of the separation membrane may occur, whereas if the ratio exceeds 2, then the production costs may sometimes increase.

By using the sterilization method according to an embodiment of the present invention, the nitrosamine compound concentration in the sterilization treated water can be reduced, for example, to not more than 100 ng/L, and preferably to 10 ng/L or less.

Examples of the bromine-based oxidizing agent include bromine (liquid bromine), bromine chloride, bromic acid, bromate salts, and hypobromous acid and the like. The hypobromous acid may be produced by reacting a bromide such as sodium bromide with a chlorine-based oxidizing agent such as hypochlorous acid.

Among these oxidizing agents, compared with a formulation composed of “hypochlorous acid, a bromine compound and sulfamic acid” and a formulation composed of “bromine chloride and sulfamic acid” and the like, formulations that use bromine such as “bromine and a sulfamic acid compound (a mixture of bromine and a sulfamic acid compound)” or a “reaction product of bromine and a sulfamic acid compound” tend to exhibit lower production of the by-product bromic acid and are less likely to cause degradation of the separation membrane in those cases where a separation membrane treatment is conducted following the sterilization treatment, and are consequently preferred as the antibacterial agent.

In other words, in the sterilization method according to an embodiment of the present invention, bromine and a sulfamic acid compound (a mixture of bromine and a sulfamic acid compound) are preferably added to the precursor-containing water. Further, addition of a reaction product of bromine and a sulfamic acid compound to the precursor-containing water is also preferred.

Examples of the bromine compound include sodium bromide, potassium bromide, lithium bromide, ammonium bromide and hydrobromic acid. Among these, in terms of production costs and the like, sodium bromide is preferred.

Examples of the chlorine-based oxidizing agent include chlorine gas, chlorine dioxide, hypochlorous acid or salts thereof, chlorous acid or salts thereof, chloric acid or salts thereof, perchloric acid or salts thereof, and chlorinated isocyanuric acid or salts thereof. Among these, examples of the salts include alkali metal salts of hypochlorous acid such as sodium hypochlorite and potassium hypochlorite, alkaline earth metal salts of hypochlorous acid such as calcium hypochlorite and barium hypochlorite, alkali metal salts of chlorous acid such as sodium chlorite and potassium chlorite, alkaline earth metal salts of chlorous acid such as barium chlorite, other metal salts of chlorous acid such as nickel chlorite, alkali metal salts of chloric acid such as ammonium chlorate, sodium chlorate and potassium chlorate, and alkaline earth metal salts of chloric acid such as calcium chlorate and barium chlorate. Any one of these chlorine-based oxidizing agents may be used alone, or a combination of two or more oxidizing agents may be used. In terms of ease of handling and the like, the use of sodium hypochlorite as the chlorine-based oxidizing agent is preferred.

The sulfamic acid compound is a compound represented by general formula (1) shown below.

R₂NSO₃H (1)

(In the formula, each R independently represents a hydrogen atom or an alkyl group of 1 to 8 carbon atoms.)

Examples of the sulfamic acid compound, in addition to sulfamic acid (amidosulfuric acid) in which the two R groups are both hydrogen atoms, include sulfamic acid compounds in which one of the two R groups is a hydrogen atom and the other is an alkyl group of 1 to 8 carbon atoms, such as N-methylsulfamic acid, N-ethylsulfamic acid, N-propylsulfamic acid, N-isopropylsulfamic acid and N-butylsulfamic acid, sulfamic acid compounds in which the two R groups are both alkyl groups of 1 to 8 carbon atoms, such as N,N-dimethylsulfamic acid, N,N-diethylsulfamic acid, N,N-dipropylsulfamic acid, N,N-dibutylsulfamic acid, N-methyl-N-ethylsulfamic acid and N-methyl-N-propylsulfamic acid, and sulfamic acid compounds in which one of the two R groups is a hydrogen atom and the other is an aryl group of 6 to 10 carbon atoms, such as N-phenylsulfamic acid, as well as salts of the above acids. Examples of the sulfamic acid salts include alkali metal salts such as sodium salts and potassium salts, alkaline earth metal salts such as calcium salts, strontium salts and barium salts, other metal salts such as manganese salts, copper salts, zinc salts, iron salts, cobalt salts and nickel salts, as well as ammonium salts and guanidine salts. One of these sulfamic acid compounds or salts may be used alone, or a combination of two or more compounds or salts may be used. In terms of the environmental impact and the like, the use of sulfamic acid (amidosulfuric acid) as the sulfamic acid compound is preferred.

In the sterilization method according to an embodiment of the present invention, an alkali may also be introduced into the precursor-containing water. Examples of the alkali include alkali hydroxides such as sodium hydroxide and potassium hydroxide. In terms of achieving good product stability and the like at low temperatures, a combination of sodium hydroxide and potassium hydroxide may also be used. Further, the alkali may also be used not as a solid, but in the form of an aqueous solution.

By using the sterilization method according to an embodiment of the present invention, the amount of nitrosamine compound produced can be suppressed, but in those cases where a small amount of nitrosamine compound is produced in the sterilization treatment, in order to remove the produced nitrosamine compound, at least one treatment among a separation membrane treatment and an oxidative degradation treatment is preferably conducted at a stage subsequent to the sterilization treatment in which the stabilized composition is added to the precursor-containing water, and conducting both a separation membrane treatment and an oxidative degradation treatment is particularly preferred. Because the sterilization method according to an embodiment of the present invention is able to suppress the amount of nitrosamine compound produced, the electric power used in the subsequent oxidative degradation treatment can be reduced, enabling a reduction in the treatment costs.

Examples of the separation membrane include a reverse osmosis membrane (RO membrane), nanofiltration membrane (NF membrane) microfiltration membrane (MF membrane) and ultrafiltration membrane (UF membrane). Among these, the separation membrane biofouling suppression provided by the sterilization method of an embodiment of the present invention can be applied particularly favorably to reverse osmosis membranes (RO membranes). Further, the separation membrane biofouling suppression provided by the sterilization method of an embodiment of the present invention can be applied favorably to polyamide-based polymer membranes, which are currently the most widely used reverse osmosis membranes. Polyamide-based polymer membranes have comparatively low resistance to oxidizing agents, and if free chlorine or the like is kept in continuous contact with a polyamide-based polymer membrane, then a marked deterioration in membrane performance tends to occur. However, in the water treatment method according to an embodiment of the present invention, by employing the biofouling suppression method provided by the sterilization method of an embodiment of the present invention, this type of marked deterioration in membrane performance is less likely to occur, even for polyamide-based polymer membranes.

Examples of oxidative degradation devices for conducting the oxidative degradation treatment include ozone generators and ultraviolet irradiation devices. An advanced oxidation process (AOP) may also be conducted as the oxidative degradation treatment. Examples of the advanced oxidation process include UV oxidation treatments using hydrogen peroxide, ozone, or hypochlorous acid as the oxidizing agent, and oxidation treatments using ozone and hydrogen peroxide.

Examples of water treatment devices that may use the sterilization method according to an embodiment of the present invention include water treatment devices containing, for example, a biological treatment device that subjects the water to be treated to a biological treatment, an addition unit that adds a stabilized composition containing a bromine-based oxidizing agent or chlorine-based oxidizing agent and a sulfamic acid compound to the biologically treated water (precursor-containing water) that contains a nitrosamine compound precursor, a separation membrane device that conducts a separation membrane treatment such as a reverse osmosis membrane treatment of the sterilization treated water to which the stabilized composition has been added, and an oxidative degradation device that conducts an oxidative degradation treatment on the permeate from the separation membrane treatment.

Further examples include water treatment devices containing a biological treatment device that subjects the water to be treated to a biological treatment, a membrane filtration device that conducts a membrane filtration treatment of the biologically treated water using an ultrafiltration membrane (UF membrane) or the like, an addition unit that adds a stabilized composition containing a bromine-based oxidizing agent or a chlorine-based oxidizing agent and a sulfamic acid compound to at least one of the biologically treated water and the filtration treated water (the precursor-containing water), a separation membrane device that conducts a separation membrane treatment such as a reverse osmosis membrane treatment of the sterilization treated water to which the stabilized composition has been added, and an oxidative degradation device that conducts an oxidative degradation treatment on the permeate from the separation membrane treatment. A storage tank (first storage tank) for storing the biologically treated water may be provided between the biological treatment device and the membrane filtration device, another storage tank (second storage tank) for storing the membrane filtration treated water may be provided between the membrane filtration device and the separation membrane device, and the stabilized composition containing a bromine-based oxidizing agent or chlorine-based oxidizing agent and a sulfamic acid compound may be added in at least one of a location between the biological treatment device and the first storage tank, a location between the first storage tank and the membrane filtration device, a location between the membrane filtration device and the second storage tank, and a location between the storage tank and the separation membrane device. The oxidative degradation treated water that has undergone the oxidative degradation treatment may be reused, or may be discharged into the environment (for example, into a groundwater vein or the like). The concentrate from the separation membrane treatment (for example, the RO concentrate from a reverse osmosis membrane treatment) may be discharged into the environment (for example, into the ocean or the like).

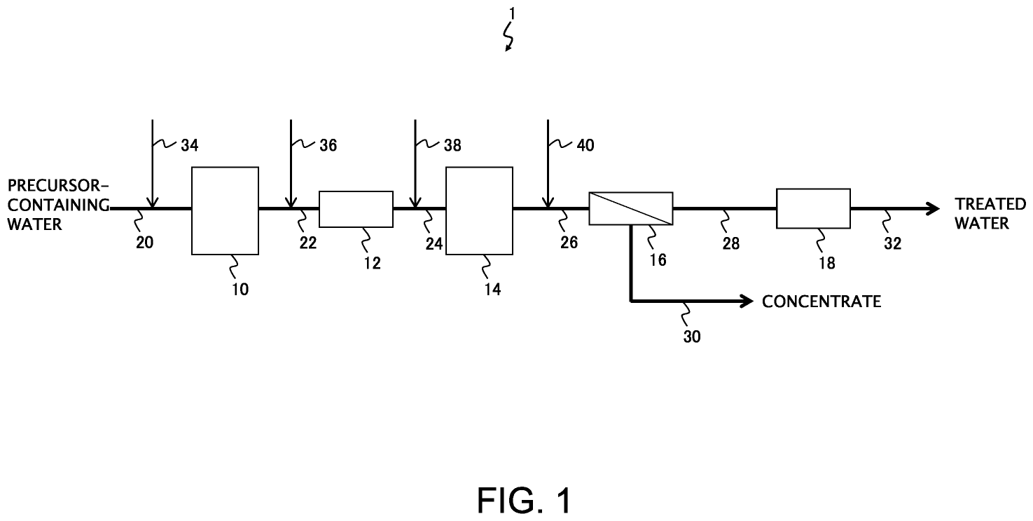

FIG. 1 illustrates the schematic outline of one example of this type of water treatment device. The water treatment device 1 of FIG. 1 includes a first storage tank 10, a membrane filtration device 12, a second storage tank 14, a separation membrane device 16, and an oxidative degradation device 18.

In the water treatment device 1 of FIG. 1, a line 20 is connected to the inlet of the first storage tank 10. The outlet of the first storage tank 10 and the inlet of the membrane filtration device 12 are connected by a line 22. The outlet of the membrane filtration device 12 and the inlet of the second storage tank 14 are connected by a line 24. The outlet of the second storage tank 14 and the inlet of the separation membrane device 16 are connected by a line 26. The permeate outlet of the separation membrane device 16 and the inlet of the oxidative degradation device 18 are connected by a line 28, and a line 30 is connected to the concentrate outlet of the separation membrane device 16. A line 32 is connected to the outlet of the oxidative degradation device 18. A stabilized composition addition line 34, 36, 38 or 40 for adding the stabilized composition is connected to at least one of the lines 20, 22, 24 and 26. The water treatment device 1 may also include a biological treatment device at a stage prior to the first storage tank 10.

The precursor-containing water that represents the treatment target (for example, a biologically treated water from a biological treatment device or the like) is passed through the line 20 and fed into the first storage tank 10 as necessary, and following storage, is passed through the line 22 and fed into the membrane filtration device 12. In the membrane filtration device 12, a membrane filtration treatment is conducted (the membrane filtration step). The membrane filtration treated water obtained from the membrane filtration treatment is passed through the line 24 and fed into the second storage tank 14 as necessary, and following storage, is passed through the line 26 and fed into the separation membrane device 16. A stabilized composition containing a bromine-based oxidizing agent or a chlorine-based oxidizing agent and a sulfamic acid compound is added through at least one of the lines 20, 22, 24 and 26 (the addition step). In the separation membrane device 16, the sterilization treated water to which the stabilized composition has been added is subjected to a separation membrane treatment such as a reverse osmosis membrane treatment (the separation membrane treatment step). The permeate obtained in the separation membrane treatment is passed through the line 28 and fed into the oxidative degradation device 18. The concentrate obtained in the separation membrane treatment is passed through the line 30 and discharged. In the oxidative degradation device 18, the permeate is subjected to an oxidative degradation treatment (the oxidative degradation treatment step). The oxidative degradation treated water obtained in the oxidative degradation treatment is passed through the line 32 and discharged as a treated water. The stabilized composition may also be added to the first storage tank 10 and/or the second storage tank 14.

By adding the stabilized composition containing a bromine-based oxidizing agent or chlorine-based oxidizing agent and a sulfamic acid compound at a stage prior to the separation membrane device, fouling of the separation membrane is suppressed. By suppressing fouling of the separation membrane, concentration polarization on the separation membrane surface is suppressed, and therefore the separation membrane rejection rate of solutes (for example, nitrosamine compounds) can be maintained at a high level. Accordingly, the amount of nitrosamine compound inflow into the permeate of the separation membrane is suppressed, and any nitrosamine compound can be effectively degraded in the subsequent oxidative degradation treatment device, enabling the overall water treatment device to effectively remove nitrosamine compounds.

Drinking water can be produced using the water system sterilization method and the method of removing a nitrosamine compound from a water system described above. For example, a drinking water can be produced by adding a stabilized composition containing a bromine-based oxidizing agent or a chlorine-based oxidizing agent and a sulfamic acid compound to a precursor-containing water that contains a nitrosamine compound precursor, and subsequently conducting a reverse osmosis membrane treatment. This enables a drinking water having a low nitrosamine compound content to be produced from the precursor-containing water that contains a nitrosamine compound precursor. The nitrosamine compound concentration in the obtained drinking water can be reduced, for example, to not more than 100 ng/L, and preferably to 10 ng/L or less.

An example of the precursor-containing water used to produce the drinking water is secondary treated sewage.

### EXAMPLES

The present invention is described below in further detail using a series of examples and comparative examples, but the present invention is in no way limited by the following examples.

[Preparation of Stabilized Hypobromous Acid Composition (Bromine Base: Composition 1)]

Liquid bromine: 17 wt %, sulfamic acid: 14 wt %, sodium hydroxide: 18 wt % and water: the balance were mixed together under a nitrogen atmosphere to prepare a stabilized hypobromous acid composition (composition 1). The pH of the composition 1 was 14, and the effective halogen concentration (effective chlorine equivalent concentration) was 7.5 wt %.

[Preparation of Monochloramine (Composition 2)]

Ammonium chloride: 0.15 wt % and a 12% aqueous solution of sodium hypochlorite: 1.0 wt % were added separately to water to prepare a composition 2.

[Preparation of Stabilized Hypobromous Acid Composition (Chlorine-Based Oxidizing Agent+Bromide Ion Base: Composition 3)]

Sodium bromide: 11 wt %, a 12% aqueous solution of sodium hypochlorite: 50 wt %, sodium sulfamate: 14 wt %, sodium hydroxide: 8 wt %, and water: the balance were mixed together to prepare a composition. The pH of the composition 3 was 14, and the effective halogen concentration (effective chlorine equivalent concentration) was 6 wt %. A detailed description of the method for preparing the composition 3 is presented below.

A reaction container was charged with 17 g of water, 11 g of sodium bromide was added, stirred and dissolved, 50 g of a 12% aqueous solution of sodium hypochlorite was then added and mixed, 14 g of sodium sulfamate was added, stirred and dissolved, and then 8 g of sodium hydroxide was added, stirred and dissolved to obtain the target composition 3.

[Preparation of Stabilized Hypobromous Acid Composition (Bromine Chloride Base: Composition 4)]

A composition containing bromine chloride, sodium sulfamate and sodium hydroxide was used. The pH of the composition was 14, and the effective halogen concentration (effective chlorine equivalent concentration) was 7 wt %.

[Preparation of Stabilized Hypochlorous Acid Composition (Composition 5)]

A 12% aqueous solution of sodium hypochlorite: 50 wt %, sulfamic acid: 10 wt %, sodium hydroxide: 8 wt %, and water: the balance were mixed together to prepare a composition. The pH of the composition was 14, and the effective halogen concentration (effective chlorine equivalent concentration) was 6 wt %.

<Effect of Type of Antibacterial Agent on NDMA Production>

In order to investigate the effect of the type of antibacterial agent on the production of NDMA, the following Test 1 (test water: secondary treated sewage), Test 2 (test water: pure water+DMA), Test 3 (test water: pure water+TMA) and Test 4 (test water: pure water+DMBzA) were conducted.

(Test Conditions 1)

Test method: the reagent was added to the test water, the pH was adjusted to 6, and after standing for 120 hours, the NDMA concentration was measured.

Test water: secondary treated sewage (NDMA production potential: 1,229 ng/L)

Reagents: the composition 1 (Example 1-1) and the composition 2 (Comparative Example 1-1)

Reagent concentration: the reagent was added in sufficient amount to achieve an effective halogen concentration (effective chlorine equivalent concentration) of 10 mg/L

Method for measuring effective halogen concentration: measured by the DPD method using a residual chlorine analyzer (DR-3900 manufactured by Hach Company) Reaction water temperature: 25° C.

Reaction time: 120 hours NDMA measurement method: in accordance with the method disclosed in Non-Patent Document 3, measurement was conducted using high performance liquid chromatography (LC-10ADvp, SIL-10ADvp, CTO-10ACvp, manufactured by Shimadzu Corporation), an anion removal device (manufactured by Nichiri Manufacturing Co., Ltd.), a photochemical reactor (manufactured by Nichiri Manufacturing Co., Ltd.), and a chemiluminescence detector (CL-2027 plus, manufactured by JASCO Inc.).

Measurement was conducted using an InertSustain AQ-C18 column manufactured by GL Sciences Inc., and a 1 mM phosphate buffer—methanol mixed solution (mixing ratio: 95:5, pH: 6.9) as the eluent.

(Test Results)

The test results are shown in Table 1.

TABLE 1
Amount of NDMA produced for each antibacterial agent

| | | NDMA concentration |
|---|---|---|
| | Antibacterial | following test |
| | agent added | [ng/L] |
| Example 1-1 | Composition 1 | 55 |
| Comparative | Composition 2 | 1229 |
| Example 1-1 | | |

Compared with the chloramine of Comparative Example 1, the stabilized composition of the example resulted in a markedly lower amount of NDMA produced.

(Test Conditions 2)

Test method: the reagent was added to the test water, the pH was adjusted to 6, and after standing for 120 hours, the NDMA concentration was measured.

Test water: pure water+dimethylamine (DMA) (DMA concentration: 100 μg/L, NDMA production potential: 173 ng/L)

Reagents: the composition 1 (Example 1-2) and the composition 2 (Comparative Example 1-2)

Reagent concentration: the reagent was added in sufficient amount to achieve an effective halogen concentration (effective chlorine equivalent concentration) of 10 mg/L

Method for measuring effective halogen concentration: measured by the DPD method using a residual chlorine analyzer (DR-3900 manufactured by Hach Company)

Reaction water temperature: 25° C.

Reaction time: 120 hours

NDMA measurement method: measurement was conducted using high performance liquid chromatography and a chemiluminescence detector, using the same method as that described for Test Conditions 1

(Test Results)

The test results are shown in Table 2.

TABLE 2
Amount of NDMA produced for each antibacterial agent

| | | NDMA concentration |
|---|---|---|
| | Antibacterial | following test |
| | agent added | [ng/L] |
| Example 1-2 | Composition 1 | 32 |
| Comparative | Composition 2 | 173 |
| Example 1-2 | | |

Compared with the chloramine of Comparative Example 1, the stabilized composition of the example resulted in a markedly lower amount of NDMA produced.

(Test Conditions 3)

Test method: the reagent was added to the test water, the pH was adjusted to 6, and after standing for 120 hours, the NDMA concentration was measured.

Test water: pure water+trimethylamine (TMA) (TMA concentration: 100 μg/L, NDMA production potential: 115 ng/L)

Reagents: the composition 1 (Example 1-3) and the composition 2 (Comparative Example 1-3) Reagent concentration: the reagent was added in sufficient amount to achieve an effective halogen concentration (effective chlorine equivalent concentration) of 10 mg/L

Method for measuring effective halogen concentration: measured by the DPD method using a residual chlorine analyzer (DR-3900 manufactured by Hach Company)

Reaction water temperature: 25° C.

Reaction time: 120 hours

NDMA measurement method: measurement was conducted using high performance liquid chromatography and a chemiluminescence detector, using the same method as that described for Test Conditions 1

(Test Results)

The test results are shown in Table 3.

TABLE 3
Amount of NDMA produced for each antibacterial agent

| | | NDMA concentration |
|---|---|---|
| | Antibacterial | following test |
| | agent added | [ng/L] |
| Example 1-3 | Composition 1 | 17 |
| Comparative | Composition 2 | 115 |
| Example 1-3 | | |

Compared with the chloramine of Comparative Example 1, the stabilized composition of the example resulted in a markedly lower amount of NDMA produced.

(Test Conditions 4)

Test method: the reagent was added to the test water, the pH was adjusted to 6, and after standing for 120 hours, the NDMA concentration was measured.

Test water: pure water+N,N-dimethylbenzylamine (DMBzA) (DMBzA concentration: 100 μg/L, NDMA production potential: 39,500 ng/L)

Reagents: the composition 1 (Example 1-4) and the composition 2 (Comparative Example 1-4)

Reagent concentration: the reagent was added in sufficient amount to achieve an effective halogen concentration (effective chlorine equivalent concentration) of 10 mg/L

Method for measuring effective halogen concentration: measured by the DPD method using a residual chlorine analyzer (DR-3900 manufactured by Hach Company)

Reaction water temperature: 25° C.

Reaction time: 120 hours

NDMA measurement method: measurement was conducted using high performance liquid chromatography and a chemiluminescence detector, using the same method as that described for Test Conditions 1

(Test Results)

The test results are shown in Table 4.

TABLE 4
Amount of NDMA produced for each antibacterial agent

| | | NDMA concentration |
|---|---|---|
| | Antibacterial | following test |
| | agent added | [ng/L] |
| Example 1-4 | Composition 1 | 16 |
| Comparative | Composition 2 | 39,500 |
| Example 1-4 | | |

Compared with the chloramine of Comparative Example 1, the stabilized composition of the example resulted in a markedly lower amount of NDMA produced.

<Effects of Antibacterial Agent Concentration and Reaction Time on NDMA Production>

In order to investigate the effects of the antibacterial agent concentration and the reaction time on the production of NDMA, the following Test 5 (test water: secondary treated sewage) and Test 6 (test water: pure water+DMA) were conducted.

(Test Conditions 5)

Test method: the reagent was added to the test water, the pH was adjusted to 6, and after standing for a prescribed period of time, the NDMA concentration was measured.

Test water: secondary treated sewage (NDMA production potential: 1,229 ng/L) Reagent: the composition 1 (Example 1-5)

Reagent concentration: the reagent was added in sufficient amount to achieve an effective halogen concentration (effective chlorine equivalent concentration) of 1 mg/L, 3 mg/L or 10 mg/L

Method for measuring effective halogen concentration: measured by the DPD method using a residual chlorine analyzer (DR-3900 manufactured by Hach Company)

Reaction water temperature: 25° C.

Reaction time: 0 hours, 5 hours, 120 hours

NDMA measurement method: measurement was conducted using high performance liquid chromatography and a chemiluminescence detector, using the same method as that described for Test Conditions 1

(Test Results)

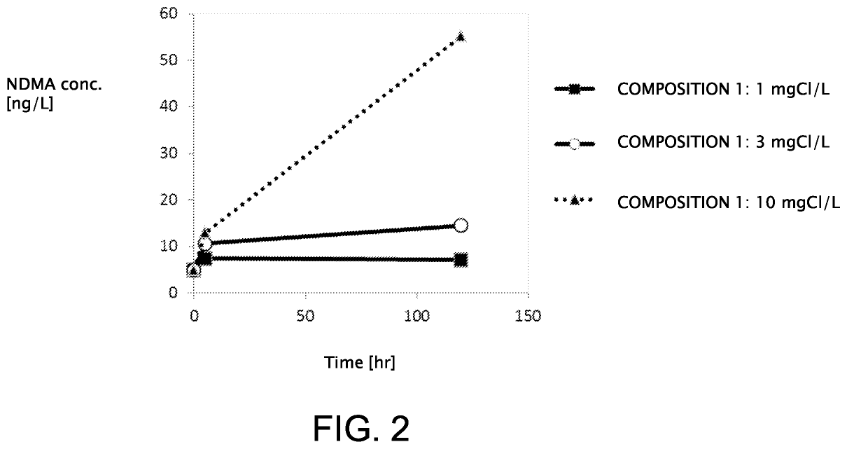

The effects of the antibacterial agent concentration and the reaction time on the amount of NDMA produced in Example 1-5 are illustrated in FIG. 2.

It is evident that the reaction time, namely the time of continuous contact between the precursor-containing water and the stabilized composition, is preferably not more than 5 hours, and that the added concentration of the stabilized composition is preferably not more than 3 mgCl/L.

(Test Conditions 6)

Test method: the reagent was added to the test water, the pH was adjusted to 6, and after standing for a prescribed period of time, the NDMA concentration was measured.

Test water: pure water+dimethylamine (DMA) (DMA concentration: 100 μg/L, NDMA production potential: 173 ng/L)

Reagent: the composition 1 (Example 1-6)

Reagent concentration: the reagent was added in sufficient amount to achieve an effective halogen concentration (effective chlorine equivalent concentration) of 1 mg/L, 3 mg/L or 10 mg/L

Method for measuring effective halogen concentration: measured by the DPD method using a residual chlorine analyzer (DR-3900 manufactured by Hach Company)

Reaction water temperature: 25° C.

Reaction time: 0 hours, 5 hours, 120 hours

NDMA measurement method: measurement was conducted using high performance liquid chromatography and a chemiluminescence detector, using the same method as that described for Test Conditions 1

(Test Results)

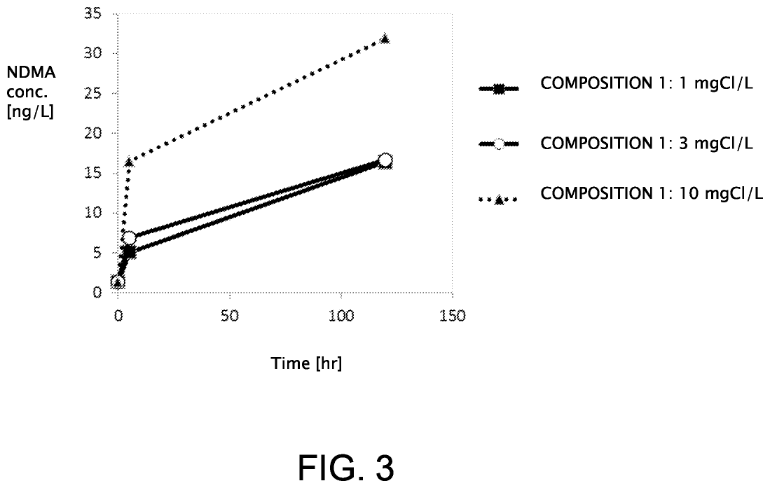

The effects of the antibacterial agent concentration and the reaction time on the amount of NDMA produced in Example 1-6 are illustrated in FIG. 3.

It is evident that the reaction time, namely the time of continuous contact between the precursor-containing water and the stabilized composition, is preferably not more than 5 hours, and that the added concentration of the stabilized composition is preferably not more than 3 mgCl/L.

<Sterilization Test 1>

The sterilizing power of antibacterial agents against a simulated water was compared under the following conditions.

(Test Conditions)

Simulated water: a simulated water prepared by adding an ordinary broth to Sagimihara well water, and then adjusting the mixture to achieve a general bacterial count of 8.5×10⁶ CFU/mL

Reagent: the composition 1 (Example 1-7) and the composition 2 (Comparative Example 1-5)

Reagent concentration: the reagent was added in sufficient amount to achieve an effective halogen concentration (effective chlorine equivalent concentration) of 1 mg/L

Method for measuring effective halogen concentration: measured by the DPD method using a residual chlorine analyzer (DR-3900 manufactured by Hach Company)

(Evaluation Method)

The general bacterial count one hour after addition of the reagent was measured using a bacterial count measurement kit (Petiifilm AC plate, manufactured by The 3M Company).

(Test Results)

The test results are shown in Table 5.

TABLE 5
Comparison of sterilizing effects of various antibacterial agents

| | Antibacterial | Initial | Bacterial count |
|---|---|---|---|
| | agent | bacterial count | after 1 hour |
| | added | [CFU/mL] | [CFU/mL] |
| Example 1-7 | Composition 1 | 8.5 × 10⁶ | 2.1 × 10⁴ |
| Comparative | Composition 2 | 8.5 × 10⁶ | 1.1 × 10⁵ |
| Example 1-5 | | | |

It is evident that the bacterial count after one hour was reduced further with the composition 1 than the composition 2, indicating a preference for the composition 1 which had superior sterilizing power.

<Sterilization Test 2>

The sterilizing power of the composition 1 against secondary treated sewage was confirmed under the following conditions.

(Test Conditions)

Test water: secondary treated sewage

Reagent: the composition 1 (Example 1-8)

Reagent concentration: the reagent was added in sufficient amount to achieve an effective halogen concentration (effective chlorine equivalent concentration) of 2 mg/L

Method for measuring effective halogen concentration: measured by the DPD method using a residual chlorine analyzer (DR-3900 manufactured by Hach Company)

(Evaluation Method)

The general bacterial count one hour after addition of the reagent was measured using a bacterial count measurement kit (Sheetcheck R2A, manufactured by Nipro Corporation).

(Test Results)

The test results are shown in Table 6.

TABLE 6
Sterilizing effects in secondary treated sewage

| | Antibacterial | Initial | Bacterial count |
|---|---|---|---|
| | agent | bacterial count | after 1 hour |
| | added | [CFU/mL] | [CFU/mL] |
| Example 1-8 | Composition 1 | 8.4 × 10⁶ | 5 × 10² |

It is evident that even in secondary treated sewage, adding the composition 1 yields a dramatic reduction in the bacterial count after one hour, indicating that a satisfactory sterilizing effect can be expected from the composition 1 even in secondary treated sewage.

<Effect 2 of Type of Antibacterial Agent on NDMA Production>

In order to investigate the effect of the type of antibacterial agent on the production of NDMA, with the exception of replacing the reagent added with the composition 3, the composition 4 or the composition 5, testing was conducted under the same conditions as Test Conditions 4.

(Test Results)

The test results are shown in Table 7.

TABLE 7
Amount of NDMA produced for each antibacterial agent

| | | NDMA concentration |
|---|---|---|
| | Antibacterial | following test |
| | agent added | [ng/L] |
| Example 1-9 | Composition 3 | 3.2 |
| Example 1-10 | Composition 4 | 2.8 |
| Example 1-11 | Composition 5 | 4.4 |

Compared with the chloramine of Comparative Example 1 described above, the stabilized compositions of the examples resulted in a markedly lower amount of NDMA produced.

<NDMA Production Potential of Various Test Waters>

The NDMA production potentials of the various test waters described below are shown in Table 8.

(Secondary Treated Sewage)

The same test water as Test Conditions 1 was used.

(Dimethylamine (DMA) Solution)

The same test water as Test Conditions 2 was used.

(Trimethylamine (TMA) Solution)

The same test water as Test Conditions 3 was used.

(N-Dimethylbenzylamine (DMBzA) Solution)

The same test water as Test Conditions 4 was used.

(Ammonia: 1 mg/L Solution)

A solution prepared by dissolving 3.15 mg of ammonium chloride in 1,000 mL of water was used.

(Ammonia: 1 mg/L+NaCl: 500 mg/L Solution)

A solution prepared by dissolving 3.15 mg of ammonium chloride and 500 mg of sodium chloride in 1,000 mL of water was used.

(Sagimihara Well Water)

Sagimihara well water was used.

TABLE 8
NDMA production potential of various test waters

| | NDMA |
|---|---|
| | production |
| | potential |
| Test water | [ng/L] |
| Secondary treated sewage | 1299 |
| DMA: 100 μg/L solution | 173 |
| TMA: 100 μg/L solution | 115 |
| DMBzA: 100 μg/L solution | 39,500 |
| Ammonia: 1 mg/L solution | 4 |
| Ammonia: 1 mg/L + NaCl: 500 mg/L solution | 4 |
| Sagimihara well water | 17 |

It is evident that compared with typical environmental water such as groundwater (Sagimihara well water), secondary treated sewage and water containing specific NDMA precursors have a much higher NDMA production potential.

<Degradation Effect on RO Membrane>

An RO membrane was immersed for a prescribed period of time in a test water containing the composition 1 or the composition 2, and the rejection rates of the RO membrane before and after the immersion were investigated. The results are shown in Table 9.

[Comparative Test on Effect on RO Membrane Rejection Rate]

Under the conditions described below, the composition 1 or the composition 2 was added in a prescribed concentration to a simulated water for immersion, the pH was adjusted to 7, and after standing for a prescribed period of time, the effect on the RO membrane rejection rate was compared.

(Immersion Conditions)
Simulated water for immersion: a water obtained by adding 1.2 g/L of sodium chloride, 0.1 g/L of calcium chloride, 0.08 g/L of sodium hydrogen carbonate, and 0.009 g/L of aluminum chloride hexahydrate to pure water was used.
Reagent: the composition 1 or the composition 2 was added in sufficient amount to achieve an effective halogen concentration (effective chlorine equivalent concentration) of 300 mg/L
pH: 7
Separation membrane: a polyamide-based polymer reverse osmosis membrane ESPA2, manufactured by Nitto Denko Corporation
Immersion time: 100 hours
Water temperature: 25° C.

(RO Membrane Rejection Rate Evaluation Conditions)
Test apparatus: flat-sheet membrane test apparatus
Simulated water for rejection rate evaluation: a water obtained by adding 1.2 g/L of sodium chloride, 0.1 g/L of calcium chloride and 0.08 g/L of sodium hydrogen carbonate, to pure water, and then adjusting the pH to 7, was used.
Permeate flow rate: 40 L/m²/h
Water temperature: 25° C.

(Method for Calculating RO Membrane Rejection Rate)

(100−[permeate conductivity/feed water conductivity]×100)

TABLE 9
Effect of various antibacterial agents on
RO membrane rejection rate

| | Rejection | Rejection |
|---|---|---|
| | rate prior to | rate after |
| | immersion | immersion |
| Reagent added | [%] | [%] |
| Composition 1 | 99.0 | 98.6 |
| Composition 2 | 98.6 | 98.2 |

The effects of both the composition 1 and the composition 2 on the RO membrane rejection rate were extremely low, and were of a similar level.

<Fouling Suppression Effect on RO Membrane>

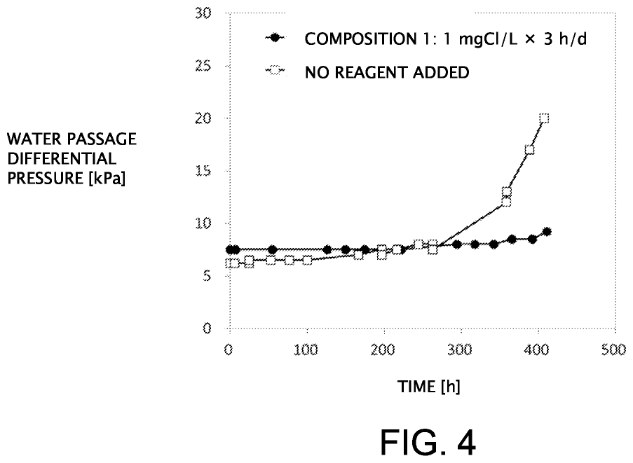

A test water containing the composition 1 was passed through a RO membrane, and the suppression effect on biofouling of the RO membrane was investigated. The change in the water passage differential pressure when the test water containing the composition 1 was passed through the RO membrane is illustrated in FIG. 4.

[Biofouling Suppression Test]

Under the conditions described below, the composition 1 was added in a prescribed concentration to a simulated wastewater, and the water passage differential pressure for the RO membrane was measured.

(Test Conditions)
Simulated wastewater: a water obtained by adding 5 mg/L of acetic acid to Sagimihara well water was used
pH: 7
Reagent: the composition 1 was added for only three hours per day in sufficient amount to generate an effective chlorine concentration of 1 mg/L
Separation membrane: a polyamide-based polymer reverse osmosis membrane ESPA2, manufactured by Nitto Denko Corporation
Water temperature: 14 to 17° C.

(Method for Calculating RO Membrane Water Passage Differential Pressure)

RO membrane water passage differential pressure=RO membrane feed water pressure—RO membrane concentrate water pressure

By using the composition 1, biofouling of the RO membrane was able to be effectively suppressed.

<Other by-Products>

The following test was conducted to investigate the effect of the type of antibacterial agent on the production of sterilization by-products other than NDMA.

(Test Conditions 1)

Test method: the reagent was added to the test water, the pH was adjusted to 7, and after standing for either 5 hours or 120 hours, the concentrations of various components were measured.

Test water: secondary treated sewage

Reagents: the composition 1 and the composition 2

Reagent concentration: the reagent was added in sufficient amount to achieve an effective halogen concentration (effective chlorine equivalent concentration) of either 5 mg/L or 100 mg/L

Method for measuring effective halogen concentration: measured by the DPD method using a residual chlorine analyzer (DR-3900 manufactured by Hach Company)

Reaction water temperature: 25° C.

Reaction time: 5 hours or 120 hours

Substances measured: trihalomethanes, bromic acid, chloric acid, haloacetic acids, and bromochloroacetonitrile

(Test Results)

The test results are shown in Table 10.

TABLE 10
Production amounts of by-products other than NDMA

| | Added | | | | Dibromo- | Bromo- | | Chloro- |
|---|---|---|---|---|---|---|---|---|
| | concen- | Reaction | Total | Chloro- | chloro | dichloro | Bromo- | acetic |
| Reagent | tration | time | trihalo | form | methane | Methane | form | acid |
| added | mgCl/L | hours | mg/L | mg/L | mg/L | mg/L | mg/L | mg/L |
| None | — | — | 0.002 | <0.001 | <0.001 | <0.001 | 0.002 | <0.002 |
| Compo- | 5 | 5 | 0.003 | <0.001 | <0.001 | <0.001 | 0.002 | <0.002 |
| sition 1 | | | | | | | | |
| Compo- | 100 | 120 | 0.22 | <0.001 | 0.009 | <0.001 | 0.21 | <0.002 |
| sition 1 | | | | | | | | |
| Compo- | 5 | 5 | 0.065 | <0.001 | 0.004 | <0.001 | 0.060 | <0.002 |
| sition 2 | | | | | | | | |
| Compo- | 100 | 120 | 0.11 | <0.001 | 0.025 | 0.009 | 0.071 | <0.002 |
| sition 2 | | | | | | | | |
| | | Dichloro- | Trichloro- | Bromo- | Dibromo- | Bromo- | | |
| | | acetic | acetic | acetic | acetic | chloro | Chloric | Bromic |
| | Reagent | acid | acid | acid | acid | Acetonitrile | acid | acid |
| | added | mg/L | mg/L | mg/L | mg/L | mg/L | mg/L | mg/L |
| | None | <0.002 | 0.004 | <0.002 | <0.002 | <0.001 | <6 | <0.001 |
| | Compo- | <0.002 | 0.004 | <0.002 | <0.002 | <0.001 | <6 | <0.001 |
| | sition 1 | | | | | | | |
| | Compo- | <0.002 | 0.005 | 0.005 | 0.037 | <0.001 | <6 | 0.001 |
| | sition 1 | | | | | | | |
| | Compo- | <0.002 | 0.005 | no data | no data | no data | <6 | no data |
| | sition 2 | | | | | | | |
| | Compo- | 0.004 | 0.006 | no datda | no data | no data | 7 | no data |
| | sition 2 | | | | | | | |

With the composition 1, the production amounts of sterilization by-products other than NDMA were also low.

As described above, by using the stabilized compositions of the examples, the amount of nitrosamine compounds produced was able to be suppressed while achieving a satisfactory sterilization effect in a precursor-containing water that contains a nitrosamine compound precursor.

### REFERENCE SIGNS LIST

1: Water treatment device
10: First storage tank
12: Membrane filtration device
14: Second storage tank
16: Separation membrane device
18: Oxidative degradation device
20, 22, 24, 26, 28, 30, 32: Line
34, 36, 38, 40: Stabilized composition addition line

1. A sterilization method for a water system, wherein a stabilized composition comprising a bromine-based oxidizing agent or a chlorine-based oxidizing agent and a sulfamic acid compound is added to a precursor-containing water that contains a nitrosamine compound precursor.

2. The sterilization method for the water system according to claim 1, wherein
the nitrosamine compound precursor includes at least one compound from among dimethylamine, trimethylamine, N,N-dimethylisopropylamine, N,N-dimethylbenzylamine, ranitidine, tetramethylthiuram disulfide, dimethyldithiocarbamate, polydiallyldimethylammonium chloride, and polymers containing an amino group.

3. The sterilization method for the water system according to claim 1, wherein
a concentration of the nitrosamine compound precursor in the precursor-containing water, expressed as a nitrosamine compound production potential, is at least 100 ng/L.

4. The sterilization method for the water system according to claim 1, wherein
the nitrosamine compound precursor includes at least one of dimethylamine, trimethylamine and N,N-dimethylbenzylamine, and a concentration of the nitrosamine compound precursor in the precursor-containing water is at least 100 μg/L.

5. The sterilization method for the water system according to claim 1, wherein
the bromine-based oxidizing agent is bromine, bromine chloride, or a reaction product of a bromine compound and a chlorine-based oxidizing agent.

6. The sterilization method for the water system according to claim 1, wherein
the chlorine-based oxidizing agent is hypochlorous acid or a salt thereof.

7. The sterilization method for the water system according to claim 1, wherein
the stabilized composition is added so that an effective halogen concentration (effective chlorine equivalent concentration) in the precursor-containing water is not more than 3 mgCl/L.

8. The sterilization method for the water system according to claim 1, wherein
a time for which the precursor-containing water and the stabilized composition are in continuous contact is not longer than 5 hours.

9. The sterilization method for the water system according to claim 1, wherein
following addition of the stabilized composition to the precursor-containing water, at least one treatment among a separation membrane treatment and an oxidative degradation treatment is conducted.

10. The sterilization method for the water system according to claim 9, wherein
a separation membrane used in the separation membrane treatment is a reverse osmosis membrane.

11. A method of removing a nitrosamine compound from a water system, wherein a stabilized composition comprising a bromine-based oxidizing agent or a chlorine-based oxidizing agent and a sulfamic acid compound is added to a precursor-containing water that contains a nitrosamine compound precursor, and a reverse osmosis membrane treatment and an oxidative degradation treatment are subsequently conducted in that order.

12. A drinking water production method, wherein a stabilized composition comprising a bromine-based oxidizing agent or a chlorine-based oxidizing agent and a sulfamic acid compound is added to a precursor-containing water that contains a nitrosamine compound precursor, and a reverse osmosis membrane treatment is subsequently conducted to produce the drinking water.

13. The drinking water production method according to claim 12, wherein
the precursor-containing water is a secondary treated sewage.
